(19) United States
(12) Patent Application Publication
(10) Pub. No.: US 2024/0416262 A1
(43) Pub. Date: Dec. 19, 2024

(54) INSET-MOUNTED WATER FILTRATION SYSTEM

(71) Applicant: PRO WATER PARTS, INC., Atlanta, GA (US)

(72) Inventors: Faizan ALY, Smyrna, GA (US); Shakeel MERCHANT, Brookhaven, GA (US); Itamar KLEINBERGER, Marietta, GA (US); Mikhail MOROZOV, Marietta, GA (US)

(21) Appl. No.: 18/746,881

(22) Filed: Jun. 18, 2024

Related U.S. Application Data
(60) Provisional application No. 63/521,770, filed on Jun. 19, 2023.

(51) Int. Cl. B01D 29/96; B01D 29/11; B01D 35/30; C02F 1/00

(52) U.S. Cl. CPC B01D 29/96; B01D 29/11; B01D 35/306; C02F 1/003; B01D 2201/29; B01D 2201/302; C02F 2201/008

(57) ABSTRACT

A filter housing, a filter-mounting cap within the housing, and a replaceable filter canister within the housing. The housing has a body with an access opening and has a lid movable between a closed position covering the access opening and an open position exposing the access opening. The filter-mounting cap is positioned within the housing, rotationally mounted relative to the housing, and repositionable between a stored position for use and a pivoted position for filter replacement. And the filter canister is positioned within the housing, has a head end portion that removably attaches to the filter-mounting cap, and has an opposite free tail end portion. In use, the filter canister can be pivoted from the stored position within the housing to the replacement position with its free tail end portion displaced from the housing so that it can be grasped to detach and replace the filter canister.

### CROSS-REFERENCE TO RELATED APPLICATION

This application claims the priority benefit of U.S. Provisional Patent Application Ser. No. 63/521,770 filed Jun. 19, 2023, the entirety of which is hereby incorporated herein by reference for all purposes.

### TECHNICAL FIELD

The present invention relates generally to the field of water filters, and more particularly to systems and methods for housing water filters in confined spaces.

### BACKGROUND

Water-filtration systems are commonly used in homes and offices to remove contaminants from tap water for improved taste and/or wellness. Examples include whole-house water-filtration systems that are installed under a sink, typically in the kitchen. While these under-sink systems have their advantages, they can be difficult to access for installation and maintenance (e.g., changing out the filter canisters/cartridges) in the small/tight space in under-sink cabinets. And they can be ill-suited to installations where there is insufficient under-sink space available such as on recreational vehicles (RVs). More particularly, water-filtration systems have traditionally been located inside RVs, but because RVs are very small with limited space, the systems can be difficult to access for replacement of filters and maintenance of other system parts.

Accordingly, it can be seen that needs exist for improvements in water-filtration systems. It is to the provision of solutions meeting these and other needs that the present invention is primarily directed.

### SUMMARY

Generally described, the present invention relates to an inset-mounted water-filtration system including a filter housing, a filter-mounting cap within the housing, and a replaceable filter canister within the housing. The housing has a body with an access opening side and has a lid movable between a closed position covering the access opening and an open position exposing the access opening. The filter-mounting cap is positioned within the housing, rotationally mounted to the housing, and repositionable between a stored position for use and a pivoted position for filter replacement. And the filter canister is positioned within the housing, has a head end portion that removably attaches to the filter-mounting cap, and has an opposite free tail end portion. In use, the filter canister can be pivoted from the stored position within the housing to the replacement position with its free tail end portion displaced from the housing so that it can be grasped to detach and replace the filter canister.

Example embodiments include the inset-mounted water-filtration system with the filter housing, the filter-mounting cap, and the replaceable filter canister. Other example embodiments include the inset-mounted water-filtration system with the filter housing and the filter-mounting cap, but without the replaceable filter canister, which can be provided separately. Still other example embodiments include installation methods of inset-mounting the water-filtration system, and maintenance methods of replacing filter canisters removably attached to the filter-mounting cap and within the filter housing of the inset-mounted water-filtration system.

These and other aspects, features, and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of example embodiments are explanatory of example embodiments of the invention, and are not restrictive of the invention, as claimed.

### BRIEF DESCRIPTION OF THE DRAWINGS

FIG. 1 is a perspective view of an inset-mounted water-filtration system according to a first example embodiment of the present invention, showing a replaceable filter canister and a filter-mounting cap in a filter housing.

FIG. 2 is a top view of the inset-mounted water-filtration system of FIG. 1.

FIG. 3 is a perspective view of the inset-mounted water-filtration system of FIG. 1, with the components unassembled in an exploded arrangement, and with internal features of the filter housing not shown for simplicity.

FIG. 4 shows the filter housing of FIG. 3, with a housing lid in an open position, and with internal features of the filter housing not shown for simplicity.

FIG. 5 shows the filter housing of FIG. 3, without the housing lid, and with internal features of the filter housing shown.

FIGS. 6, 7, and 8 are top, side, and end views, respectively, of the filter housing of FIG. 5.

FIG. 9 is a cross-sectional end view of the filter housing taken at line 9-9 of FIG. 7.

FIG. 10 is a cross-sectional side schematic view of the filter housing of FIG. 1 installed inset into a vertical wall in a vertical orientation.

FIG. 11 is a top schematic view of the inset-mounted water-filtration system of FIG. 1, with the housing lid, installed inset into a vertical wall in a horizontal orientation.

FIG. 12 is a cross-sectional end schematic view of the inset-mounted water-filtration system taken at line 12-12 of FIG. 11.

FIG. 13 is a cross-sectional end schematic view of the inset-mounted water-filtration system taken at line 13-13 of FIG. 11.

FIG. 14 shows a detail portion of the inset-mounted water-filtration system of FIG. 13, with the filter canister supported and retained in the filter housing.

FIG. 15 shows the detail portion of the inset-mounted water-filtration system of FIG. 14, with the filter canister being removed from the filter housing.

FIG. 16 is a top schematic view of the inset-mounted water-filtration system of FIG. 1, without the housing lid, with the filter canister supported and retained in the filter housing.

FIG. 17 is a cross-sectional side schematic view of the inset-mounted water-filtration system taken at line 17-17 of FIG. 16.

FIG. 18 shows the inset-mounted water-filtration system of FIG. 16, with the filter canister being pivoted out of the filter housing.

FIG. 19 is a cross-sectional side schematic view of the inset-mounted water-filtration system taken at line 19-19 of FIG. 18.

FIG. 20 is a perspective view of an inset-mounted water-filtration system according to a second example embodiment of the present invention.

FIG. 21 is a perspective view of the inset-mounted water-filtration system of FIG. 20, with the components unassembled in an exploded arrangement.

FIGS. 22, 23, and 24 are top, side, and end views, respectively, of the inset-mounted water-filtration system of FIG. 20.

FIG. 25 is a top view of the inset-mounted water-filtration system of FIG. 1, without the housing lid, with the filter canister supported and retained in the filter housing.

FIG. 26 is a cross-sectional side view of the inset-mounted water-filtration system taken at line 17-17 of FIG. 16.

FIG. 27 shows the detail portion of the inset-mounted water-filtration system of FIG. 26, showing the filter canister being retained within the filter housing.

FIG. 28 shows the inset-mounted water-filtration system of FIG. 25, with the filter canister being pivoted out of the filter housing.

FIG. 29 is a cross-sectional side view of the inset-mounted water-filtration system taken at line 29-29 of FIG. 28.

### DETAILED DESCRIPTION OF EXAMPLE EMBODIMENTS

The present invention may be understood more readily by reference to the following detailed description of example embodiments taken in connection with the accompanying drawing figures, which form a part of this disclosure. It is to be understood that this invention is not limited to the specific devices, methods, conditions, or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

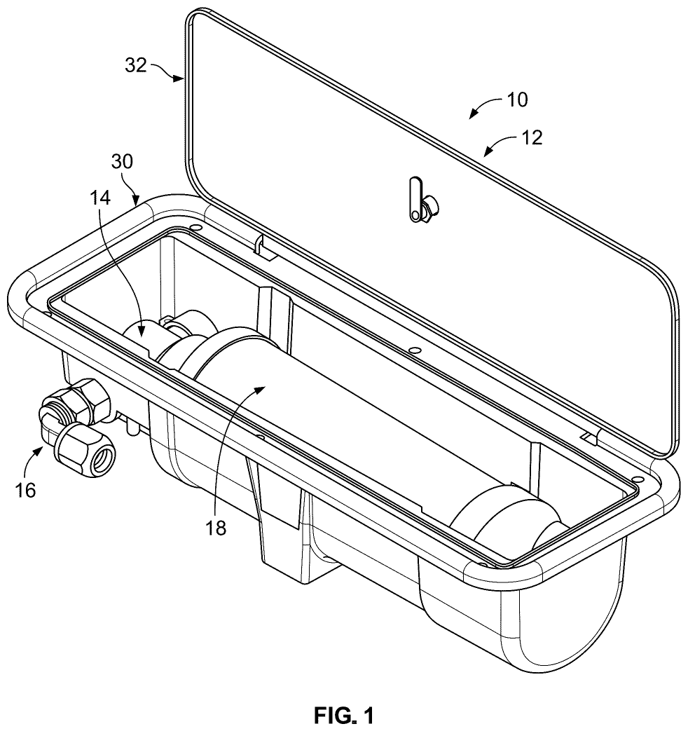

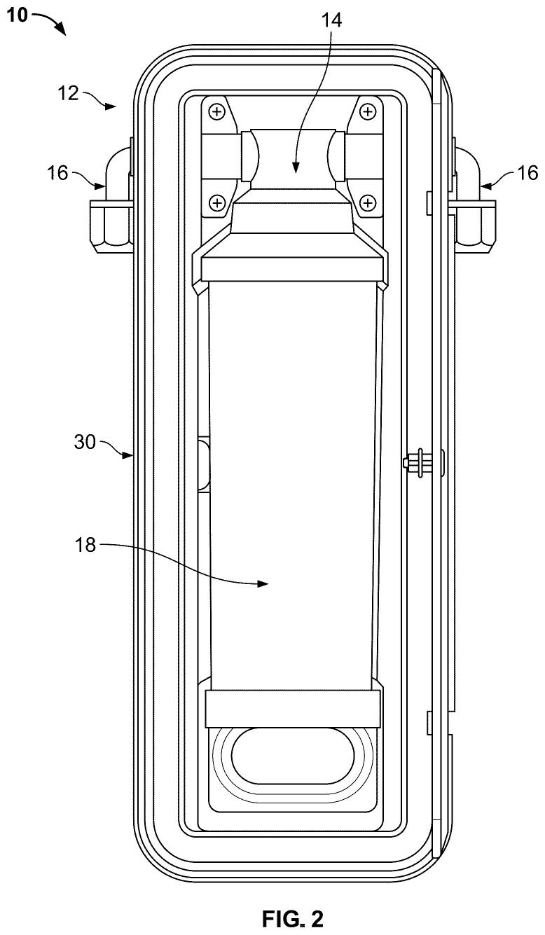

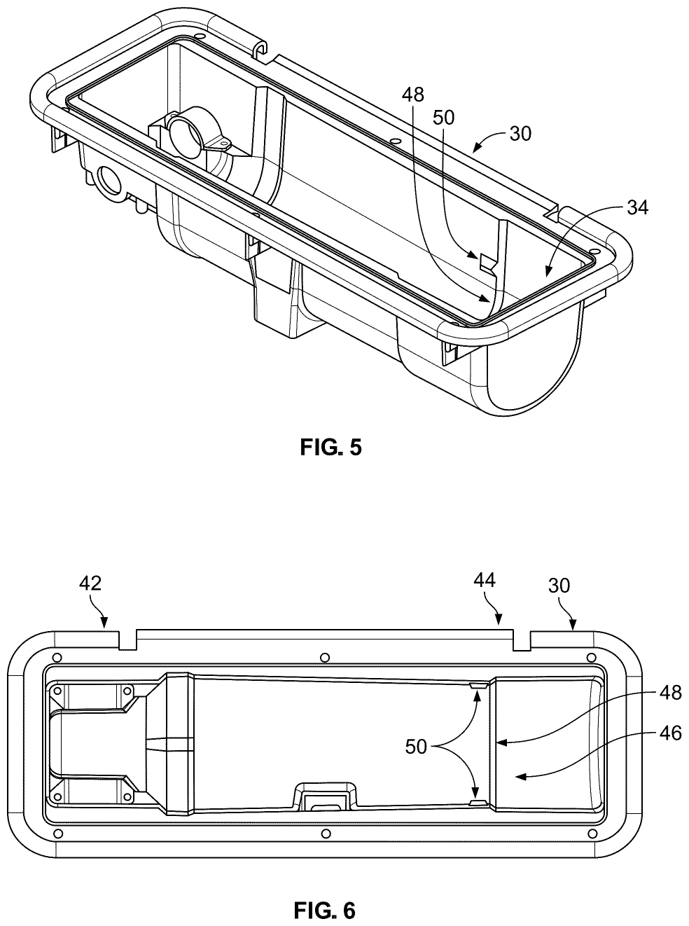

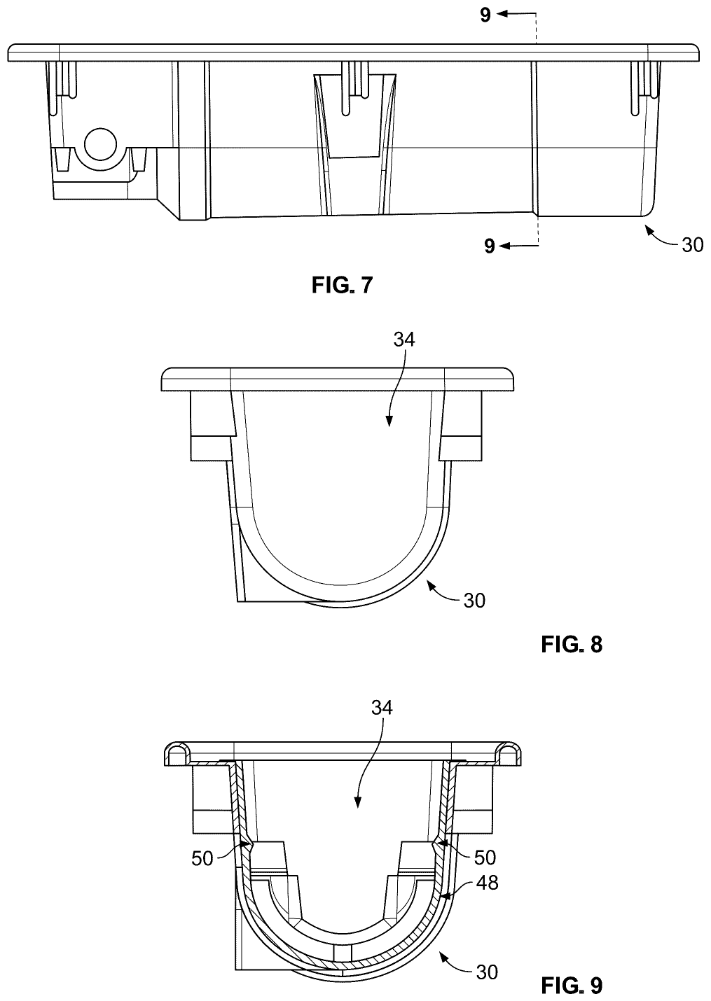

With reference now to the drawing figures, wherein like reference numbers represent corresponding parts throughout the several views, FIGS. 1-19 show an inset-mounted water-filtration system 10 according to a first example embodiment. The depicted system 10 is designed for use with filter media for on-site filtration of water for drinking purposes (e.g., on or in recreational vehicles (RVs), residential buildings, commercial offices, etc.). In other embodiments, the system can be adapted for use with filter media for water for other purposes, or for use with filter media for other fluids. As such, the depicted system 10 is described with reference to filtration of water, though other embodiments include systems for use with filter media for other fluids for other applications and purposes.

The depicted system 10 is designed for installation inset into a surface 8, typically a wall but also for example a floor, ceiling, door, or cabinet panel. In such inset installations, an access side (e.g., the top) of the system 10 is generally flush with the wall or other surface 8. Also, the depicted system 10 is designed for installation and use in RVs, for example inset into a wall 8 of the RV, typically an exterior wall of the RV, but alternatively an interior wall or other surface (including floors, ceilings, and cabinet panels), and whether flush with an exterior wall surface (accessible from outside the RV) or flush with an interior wall surface (accessible from inside). More particularly, the system can be installed in an exterior wall 8 of the RV so that it's easier to physically access for replacing the filter canisters and maintaining other parts of the system 10, and the system 10 can be locked to control such exterior access. Alternatively, the system can be installed under sinks or elsewhere (whether inset-mounted or not), in homes, offices, campers, cabins, or other inhabitable spaces (not just RVs), as may be desired.

Referring particularly to FIGS. 1-9, the water-filtration system 10 includes a filter housing 12, a filter-mounting cap 14, and two tube couplings 16, with the system 10 for use with or including a replaceable filter canister 18. The filter canister 18 removably attaches to the filter-mounting cap 14, and both of these components are received within the filter housing 12. The tube couplings 16 extend through the filter housing 12, connect to the filter-mounting cap 14 at their internal ends, and are connectable to water inlet and outlet lines (e.g., tubing) at their external ends. The filter housing 12, the filter-mounting cap 14, and the tube couplings 16 can all be conventional components made of conventional materials (e.g., hard plastic).

The replaceable filter canister 18 includes one or more filter media in a casing, and is selected for the particular filtering application. In the depicted embodiment, for example, the filter canister 18 is a conventional point-of-use (e.g., whole-house and/or under-sink) water filter. Such replacement filters can be for example EVERPURE filtration cartridges commercially available from Pentair Water Group, Inc. (Golden Valley, MN).

The filter canister 18 includes a head end portion 20 with at least one head opening (e.g., with coaxial inflow and outflow lumens) through which water enters and exits the casing, with the water being routed through the filter media within the casing between its entry and exit. The casing is watertight, so that water cannot enter or exit, except through the head opening, during the normal intended filtering use. The filter head end portion 20 also includes a filter coupling portion 22 that sealingly mates with a cap coupling portion 24 to removably attach the filter canister 18 to the filter-mounting cap 14, as described in more detail below.

The filter canister 18 also includes a tail end portion 26 that is opposite the head end portion 20. In typical embodiments, the filter tail end portion 26 includes a handle 28 that can be gripped by hand to manipulate the filter canisters 18 during detachment and reattachment relative to the filter-mounting cap 14. In the depicted embodiment, the handle 28 includes a U-shaped grip extending from the tail end portion to cooperatively form an enclosed finger hole. In other embodiments, the handle includes a knob, T-member, or other grip structure extending from the tail end, or a rubberized peripheral grip band around the tail end, that can be gripped by hand to manipulate/move the filter canisters during replacement. The handle 28 of the filter tail end portion 26 can be an integral portion of filter canister 18 or a separate part that can be removed from a spent filter canister and attached to a fresh one.

The filter housing 12 is sized and shaped to receive the filter canister 18 and the filter-mounting cap 14 with sufficient extra space for removing and replacing the filter canister 18. In typical embodiments, the filter housing 12 includes a housing body 30 and a housing lid 32, with the body 30 defining an internal space 34 (that holds the filter canister 18) and an open/access side (e.g., top), and with the lid 32 repositionable between an open position (permitting removal and replacement of the filter canisters 18) and a closed position (closing off the open/access side). The lid 32 can be movable (for repositioning) relative to the body 30 by a pivotal connection for pivoting the lid 32 (as depicted) or by another connection (e.g., by a track connection for sliding). A lock 36 (e.g., latch type) can be provided for releasably securing the lid 32 in the closed position, and the lock 36 can be a security lock (e.g., key, card, or code operated), with the security lock 36 being particularly beneficial for limiting/controlling access to the system 10 when its installed in an exterior wall of an RV with the lid 32 openable from outside the RV. In other embodiments, the filter housing has other configurations that enable the filter canisters to be removed and replaced, for example clam-shell housings (the two shell pieces can be considered the body and the lid). Also, the size of the components of the systems 10 can be readily adapted based on the filtration flow demand of a particular applications, for example, the filter canister 18 to meet a higher flow filtration demand, and the housing 12 can be accordingly longer and/or wider.

In the depicted embodiment, the filter housing 12 encloses the filter canister 18 and is watertight when in the closed position, with the filter canister 18 inside, and with the two tube couplings 16 sealingly mounted to the housing 12 and extending through two respective holes in the housing 12. For example, the housing 18 can include a peripheral gasket (not shown) extending all the way around and seated in the peripheral lip of the housing body 30 at its open side, so that the peripheral edge portions of the housing lid 32 press against the gasket to form a watertight seal. In this way, if the watertight casing of the filter canister 18, or the filter-to-cap coupling 22/24, fails and leaks during use, the water will not leak out of the housing 12 and into adjacent areas and damage them. With the filter housing 12 inset into and behind the mounting surface (e.g., wall), any water leakage and damage might not be visible for some time, and so the watertight housing 18 provides a backup watertight sealing function. The filter housing 12 also protects the filter canister 18 and the filter-mounting cap 14 from being bumped or otherwise inadvertently impacted, thereby decreasing the chances of water leakage from a damaged seal between them in the first place. In other embodiments, the filter housing can be provided by a protective unsealed framework or other structure for holding the filter canister 18, the filter-mounting cap 14, and the tube couplings 16 in place.

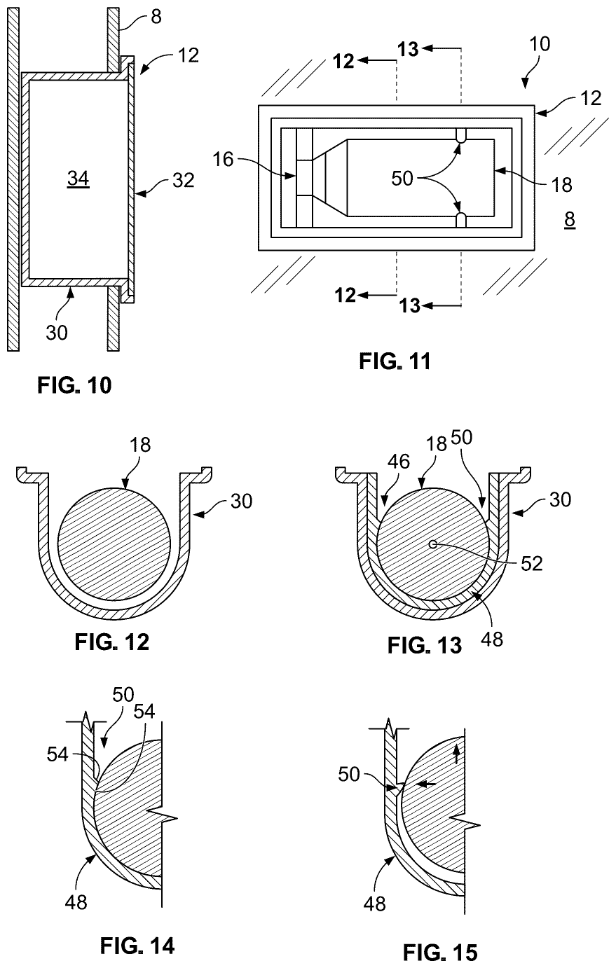

Referring additionally to FIGS. 10-11, in typical installation methods, the water-filtration system 10 is inset into a surface (e.g., a wall) 8 and secured in place by fasteners (e.g., screws 38 with tabs 40). For example, the water-filtration system 10 can be installed with the housing 12 inset mounted into a wall 8 in a vertical orientation (e.g., head portion up and tail portion down), as shown in FIG. 10. Alternatively, the water-filtration system 10 can be installed with the housing 12 inset mounted into the wall 8 in a horizontal orientation (e.g., head portion left and tail portion right), as shown in FIG. 11. With the housing 12 inset mounted into the wall 8 in these arrangements, the housing lid 32 (e.g., top) is vertical and flush with the wall 8, while the filter canister 18 and the housing body 30 are entirely behind the wall 8 (except for the lip of the housing body). The housing lid 32 being “flush” with the wall 8 does not mean the lid 32 must be precisely and literally coplanar with the wall (though it can be). Typically, the peripheral lip of the lid 32 has a relatively small thickness (e.g., about 1/16 inch to about ⅛ inch) and overlaps the peripheral lip of the wall opening, with the peripheral lip of the lid 32 thus extending slightly beyond (outwardly from) the wall 8 by the lid lip thickness (e.g., in the manner of the cover/lid of an inset-mounted electrical panel), as shown in FIG. 10.

The housing 12 typically has a sufficiently shallow depth (e.g., about 4 inches to about 6 inches) that it can be installed inset into conventional exterior and interior walls 8 of RVs, homes, and other inhabited/occupied spaces (e.g., based on the wall's internal space/depth defined for example by the wall stud), as shown in FIG. 10. This shallow depth is also suitable for mounting the housing 12 inset into an exterior wall of an RV below the floor of the inhabitable internal space of the RV. The housing 12 can be inset-mounted into an exterior wall of an RV with the housing lid 32 outside the RV (for exterior access and maintenance) or inside the RV (for interior access and maintenance). Also, the housing 12 has a sufficiently short width (e.g., about 6-8 inches) that it can be inset installed in the vertical position of FIG. 10 (e.g., between wall studs), and typically also has a sufficiently short length (e.g., about 17-20 inches) that it can be inset installed in the horizontal position of FIG. 11, into conventional interior walls 8 between two studs (e.g., with 24-inch spacings).

In addition, the filter housing 12 includes a head portion 42 and an opposite tail portion 44. The housing head portion 42 is where the filter-mounting cap 14 and the head portion 20 of the filter canister 18 are positioned, and the housing tail portion 42 is where the tail portion 26 of the filter canister 18 is positioned. The filter canister head portion 20 fixedly couples to and is supported by the filter-mounting cap 14, which is fixedly coupled to and supported by the housing 12 (e.g., directly, or indirectly via the tube couplings 16). However, the filter canister tail portion 26 is not fixedly coupled to another structure, so it's unattached and thus free to be rotated and moved through the open/access side of the housing body 30.

Referring additionally to FIGS. 12-15, to enable the water-filtration system 10 to be installed in the horizontal orientation, the tail portion 44 of the housing 12 can include a support 46 for the tail portion 26 of the filter canister 18. The filter support 46 includes at least one protruding structure that extends inwardly from the housing body 30 into the housing internal space 34 to support the filter canister tail portion 26 when the water-filtration system 10 is in the horizontal orientation with the open/access side of the housing 12 facing laterally and/or upwards. In this way, the filer canister 18 is not cantilevered from the filter-mounting cap 14 with the weight of the filter canister free tail portion 26 only supported by the coupling of the filter canister head portion 22 to the filter-mounting cap 16. Without the filter support 46, the unsupported weight of the filter canister free tail portion 26 would stress (and could result in failure of) the coupling of the filter canister head portion 22 to the filter-mounting cap 16, and thus the horizontal orientation would be prone to water leaks within the housing 12. This is particularly important for RV applications, due to movements and vibrations transmitted to the system 10 during (and caused by) travel of the RV, to secure the filter canister 18 in place in order to prevent its involuntary displacement (e.g., rattling movement) and resulting leakage.

In the depicted embodiment, as shown in FIG. 13, the filter canister 18 is cylindrical and the filter support 46 includes a curved ridge 48 that generally conforms to the curvature of the cylindrical filter canister 18. The support ridge 48 extends inwardly from the housing body 30 into the housing internal space 34 so that the filter canister tail portion 26 seats against it when the filter canister 18 is in its use position within the housing 12, but other/adjacent portions of the filter canister 18 are not contacted and supported by it (compare FIGS. 12 and 13). Also, the depicted support ridge 46 extends for an arc of greater than 180 degrees so that it contacts and supports the filter canister 18 when the water-filtration system 10 is in the horizontal orientation with the open/access side of the housing 12 facing laterally or facing upwards (or anywhere in between). This extensive (cradling/nesting) contact of the support ridge 48 to the filter canister 18 distributes loading to ensure there is no overloading. In other embodiments, the support ridge 48 is not continuous and instead is in the form of a series of ridge segments (e.g., bosses, knobs, ribs, or bearings).

In addition, in typical embodiments the housing 12 includes at least one retainer 50 that releasably secures the filter canister 18 in the housing body 30. In the depicted embodiment, the housing 12 includes two retainers 50 positioned on opposite sides of the housing 12 and extending inwardly from the housing body 30 into the housing internal space 34. The retainers 50 mechanically interfere with the filter canister 18 when it's seated in the use position within the housing 12 to secure the filter canister tail portion 26 in place (e.g., against the support ridge 48). Thus, the retainers 50 form a clamp that helps hold the filter canister 18 in place during use. For example, in RV installations, the retainers 50 secure the filter canister 18 in place with sufficient force to prevent the filter from pivoting out of place due to vibrations caused from the RV traveling during its ordinary intended use.

The retainers 50 are positioned on the housing 12 so they are closer to the open/access side of the housing that the centerline 52 of the filter canister 18. That is, when the filter canister 18 is seated in the use position, the retainers 50 are between the filter canister centerline 52 and the housing lid 32. In the depicted embodiment, for example, the retainers 50 are positioned on the housing 12 at a height from the bottom (opposite the lid 32) of the curved support ridge 48 that is greater than the radius of the cylindrical filter canister 18. The retainers 50 can be integrated into the support ridge 48 to form a single continuous structure, as depicted, or they can be separate structural elements not connected together and/or with the support ridge.

The retainers 50 can be made of a resilient material so that they resiliently deform/deflect from a retaining configuration (FIGS. 13-14) to a clearance configuration (FIG. 15) upon forceful engagement with the filter canister 18 during installation and removal of the filter canisters 18 into and from the housing 12 (e.g., as shown by the directional arrows of FIG. 15). To assist in the deflection of the retainers 50 between their retaining and clearance configurations, they typically have ramped contact surfaces 54. In this way, the retainers 50 releasably secure the filter canister 18 in the housing 12 with a snap fit. Other embodiments include other support retainers, for example spring-biased into the retaining configuration, that provide the same releasable securement functionality. In yet other embodiments, the retainer includes a strap, latch, or other conventional retaining element or device that provides the same releasable securement functionality. Other embodiments include the support retainers 50 but not the support ridge 48, or the support ridge 48 but not the support retainers 50.

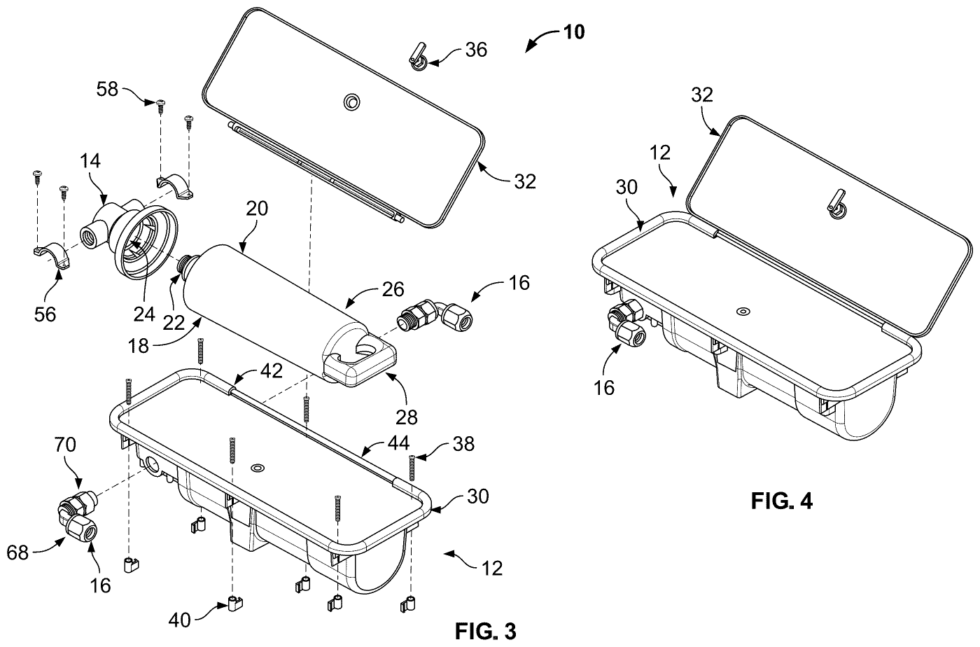

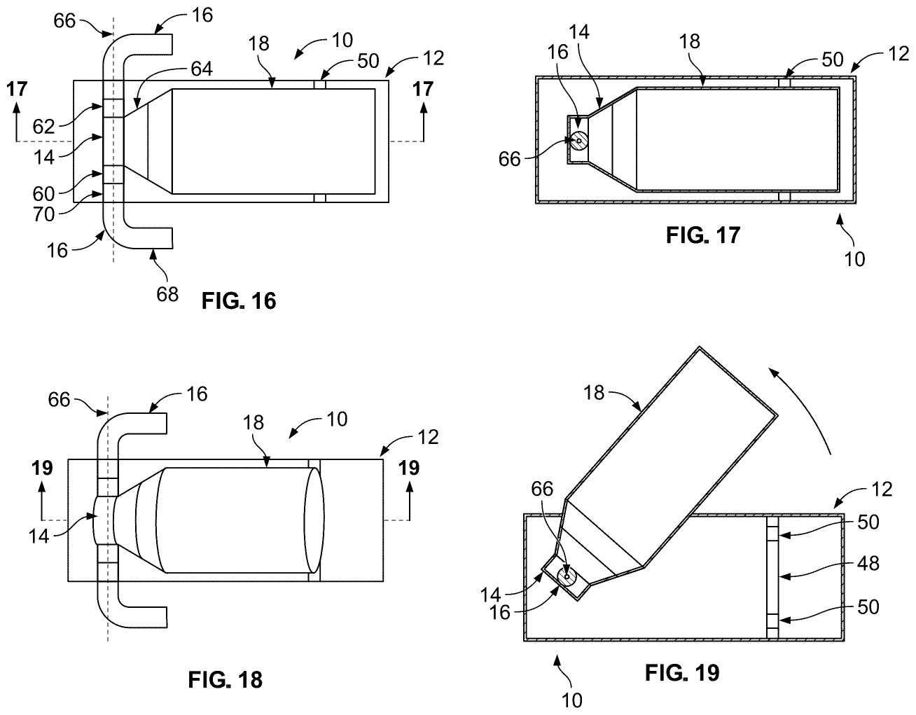

Referring additionally to FIGS. 16-19, the filter canister 18 and the filter-mounting cap 14 removably attach to each other by respective filter and cap coupling portions 22 and 24, as noted above. In the depicted embodiment, the two coupling portions 22 and 24 are mating screw threads (e.g., ½ inch NPT), so that the filter canister 18 is rotated to screw it off of and on to the filter-mounting cap 14 for replacement of the filter canister 18. The handle 28 (FIG. 3) can be used for manually applying a rotational force for filter canister 18 replacement. In other embodiments, the two coupling portions are provided by other conventional couplings that provide the removable attachment functionally for filter canister replacement (e.g., snap, friction, or bayonet fittings, or any other suitable plumbing connections).

Also, the filter-mounting cap 14 can be secured in place within the housing 12 by mounting elements, for example brackets 56 and fasteners (e.g., screws) 58 (FIG. 3). The mounting elements 56 can secure the filter-mounting cap 14 in place directly (e.g., at the inlet and outlet legs 60 and 62) or indirectly (e.g., via the tube couplings 16). The mounting elements 56 secure the filter-mounting cap 14 to the housing 12 with a fixed mounting (that does not permit pivoting) in some embodiments (e.g., with the brackets attaching non-rotating portions of the swivel tube couplings or the filter-mounting cap to the housing). Or the mounting elements 56 secure the filter-mounting cap 14 to the housing 12 with a pivotal mounting (that permits pivoting) in some embodiments (e.g., with the brackets attaching rotating portions of the tube couplings or the filter-mounting cap to the housing).

The tube couplings 16 extend through inlet and outlet openings (not shown) in the filter housing 12 with a watertight seal (e.g., conventional seal components such as rubberized grommets or washers) and their external ends (outside the housing 12) connect to inlet and outlet tubing (not shown), as noted above. The tube couplings 16 typically extend through opposite sides of the filter housing 12 (not the bottom/back or top/front/access sides), to minimize the depth for compact installation in shallow wall spaces. The tubing can be of a conventional type, such as flexible or rigid plastic or metal tubing or piping (e.g., ½ inch PEX flexible water pipe tubing). Thus, the tube couplings 16 can include tubing connectors (e.g., ½ inch PEX fittings) at their external ends. In other embodiments, the tube couplings 16 and the filter-mounting cap 14 are provided as a single integral part.

The internal ends (inside the housing 12) of the tube couplings 16 connect to the filter-mounting cap 14, as noted above. The filter-mounting cap 14 can be 3-way and T-shaped, with an inlet 60 and outlet 62 that are axially aligned, and with a filter-attaching dual-flow portion 64 perpendicularly extending from the inline inlet and outlet. As such, the internal ends of the tube couplings 16 are axially aligned with each other, with each connected to a respective one of the inlet 60 and outlet 62 of the filter-mounting cap 14. The inlet 60, the outlet 62, and the filter-attaching portion 64 are typically formed by three legs in a T shape. The filter-attaching dual-flow portion of the filter-mounting cap 14 is where the filter canister 18 removably attaches (i.e., the flow portion thus includes the cap coupling portion 24) and is in fluid communication with the filter canister 18 (e.g., the flow portion thus includes coordinating coaxial outflow and inflow lumens to provide the dual-flow functionality). Such filter-mounting caps 14 are conventional and commercially available from various plumbing suppliers.

In example embodiments, the filter-mounting cap 14 is pivotally mounted relative to the housing 12, with the axially aligned inlet 60 and outlet 62 defining a rotational axis 66 about which the filter-mounting cap 14 (and thus the attached filter canister 18) can pivot (i.e., rotate and/or swivel) relative to the housing 12. In the depicted embodiment, the filter-mounting cap 14 is pivotally mounted relative to the housing 12 by the tube couplings 16. For example, the tube couplings 16 can be swivel couplings (e.g., elbows, as depicted) each extending through an opposite side of the peripheral wall of the housing 112 with a watertight seal, and each including first and second portions 68 and 70 that define a pivotal connection and that rotate relative to each other about the rotational axis 66. The first portions 68 of the tube couplings 16 define the external ends that connect to the inlet and outlet tubing, and the second portions 70 define the internal ends that connect to the cap inlet and outlet 60 and 62. Such swivel tube couplings 16 can be for example JOHN GUEST fittings commercially available from Reliance Worldwide Corporation (Atlanta, GA).

In other embodiments, the tube couplings are fixed fittings (i.e., one-piece, non-swiveling, non-adjustable, and fixed-orientation, instead of swivel fittings), and the pivoting/rotating of the filter-mounting cap 14 (relative to the housing 12) is provided by other pivotal connections (other than swivel elbow couplings). Such other pivotal connections can be for example inserted between the tube couplings 16 and the filter-mounting cap 14 (e.g., a linear swivel fitting, or even the mating screw threads of these two parts), or included within the filter-mounting cap 14 (e.g., a swivel connection between the filter-attaching dual-flow portion 64 and the inlet and outlet portions 60 and 62).

In yet other embodiments, the tube couplings are provided by straight or T-shaped swivel couplings. In other embodiments, fixed couplings extend through the housing, and the tube couplings are internal to the housing and connect between the fixed couplings and the filter-mounting cap. In still other embodiments, the filter-mounting cap can be detached from the housing while the system is installed during use without removing the housing, and a quick-connect feature is included for this, for example the tube couplings can be quick-connect swivel couplings, or another quick-connect feature can be provided such as pins through aligned holes in telescoping segments of the tube couplings and the filter-mounting cap.

This pivotal mounting arrangement provides for improved ease of replacing the filter canisters 18, with FIGS. 16-17 showing the filter canister 18 in the use position and FIGS. 18-19 showing it pivoted out of the housing 12 to the pivoted position for replacement. In particular, after the useful life of the filter canister 18, the internal space 34 of the housing 12 can be accessed (e.g., by opening the lid 32), and the used filter canister 18 can be grasped (e.g., by the tail-portion handle 28), pivotally displaced from within the housing 12 (e.g., by angularly lifting or swinging the free tail portion 26; see angular directional arrow of FIG. 18), and detaching the filter canister 18 from the filter-mounting cap 14 (e.g., by rotating the filter canister 18 to unscrew it from the mounting cap 14). Then a fresh replacement filter canister 18 can be reattached to the filter-mounting cap 14, replaced into the housing 12, and released in the use position, and the housing can be closed, for example by reversing the previously described steps. This filter replacement method can be particularly beneficial in tight spaces such as on RVs and/or under sinks.

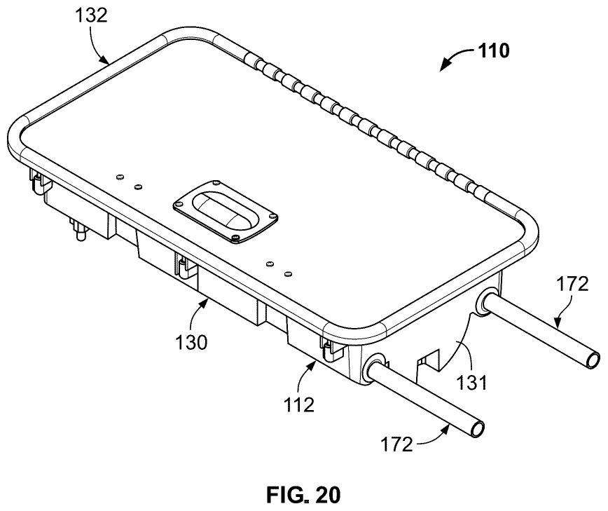

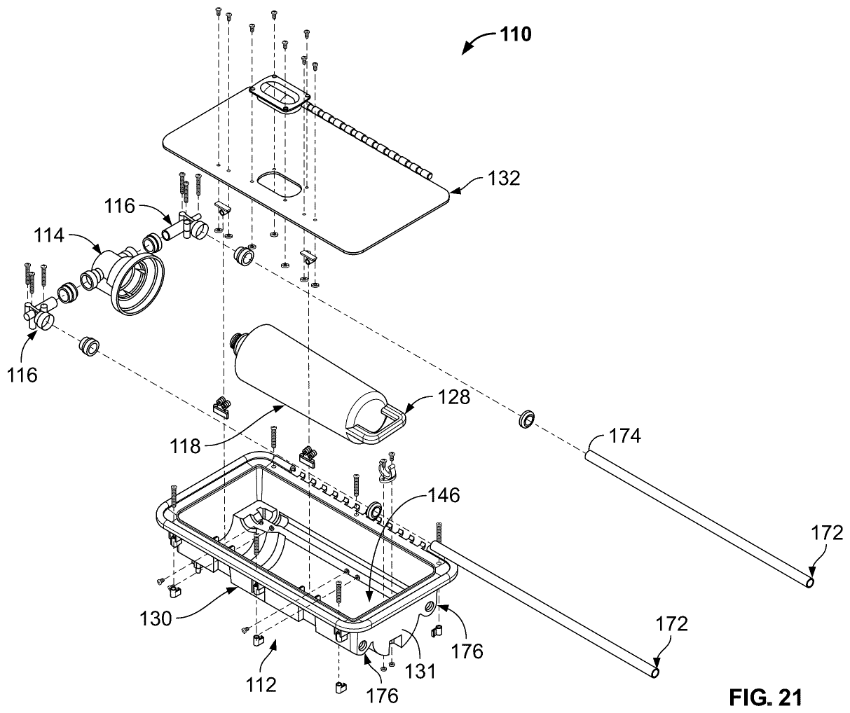

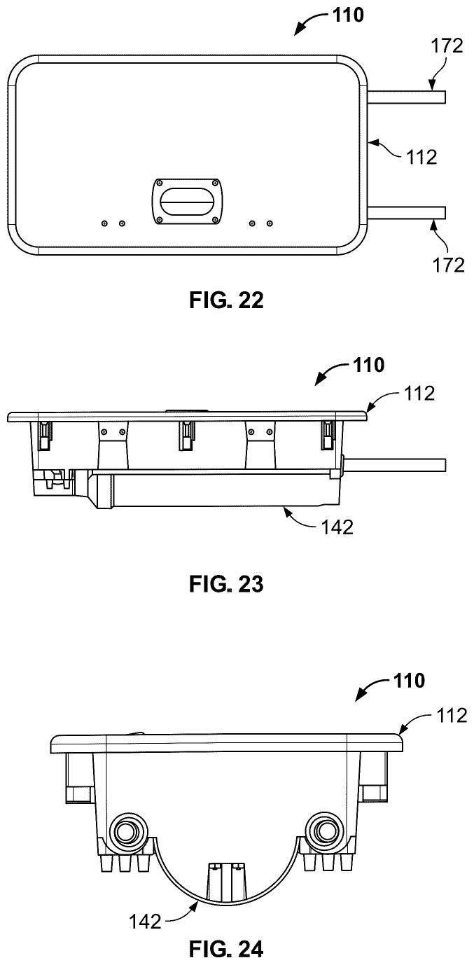

FIGS. 20-29 show an inset-mounted water-filtration system 110 according to a second example embodiment. The system 110 can have the same or similar design, construction, and use as the system 10 described above, except as noted herein. Also, the system 110 can be adapted for use with filter media for other fluids and/or other applications and purposes. As such, many common details are not repeated for simplicity and brevity.

The water-filtration system 110 includes a filter housing 112, a filter-mounting cap 114, and two tube couplings 116, with the system 110 for use with or including a replaceable filter canister 118. The filter canister 118 removably attaches to the filter-mounting cap 114, and both of these components are received within and pivotally mounted relative to the filter housing 112. The tube couplings 116 are connectable the filter-mounting cap 114 to the inlet and outlet fluid lines (e.g., tubing) 172 (optionally, the tube couplings and the filter-mounting cap can be provided as a single integral part). Also, the filter housing 112 includes a housing body 130 and a housing lid 132, with the body 130 holding the filter canister 118 and having an open/access side (e.g., top), and with the lid 132 repositionable between an open position (permitting removal and replacement of the filter canisters 118) and a closed position (closing off the open/access side so the housing is watertight). The filter housing 112, the filter-mounting cap 114, and the tube couplings 116 can all be conventional components made of conventional materials (e.g., hard plastic). The filter canister 118 can be of the same conventional type as in the first embodiment described above.

In this embodiment, however, the tube couplings 116 are positioned entirely within the housing 112, instead of extending through the housing. As such, the housing 112 is typically wider than in the first embodiment described above. The tube couplings 116 are typically elbow fittings, as in the first embodiment described above. The pivotal connections that enable the filter canister 118 to pivot (relative to the housing 112) can be provided by the tube couplings 116 (e.g., swivel elbow fittings, as in the first embodiment), or by other rotation-enabling elements (e.g., as described above for the first embodiment).

Also, the inlet and outlet tubing 172 extends through the housing 112 with a watertight seal (e.g., conventional seal components such as rubberized grommets or washers), instead of the tube couplings extending through the housing as in the first embodiment. Thus, the inlet and outlet tubing 172 has internal ends 174 within the housing 112 that connect to the tube couplings 116 within the housing. In the depicted embodiment, the inlet and outlet tubing 172 is routed through respective openings 176 in the housing 112 and connected to the tube couplings 116 during installation of the water-filtration system 110. Thus, the tubing 172 can be run from main feed and drain lines all the way to the tube couplings 116 in continuous runs. The inlet and outlet openings 176 are typically located in an endwall of the housing 112, for example the endwall 131 adjacent the tail end portion of the filter 118 (so the inlet and outlet tubing 172 extends from the tube couplings 116, along the length of the filter canister 118, and through the endwall 131, as depicted.

In other embodiments, the system can be provided with inlet and outlet tubing (sections) connected to the tube couplings, extending through the openings in the housing, and terminating at external ends outside of the housing (during installation, fluid lines are then connected at these external ends). In yet other embodiments, the inlet and outlet openings are located in the endwall of the housing adjacent the head end portion of the filter (the housing may need to be slightly longer to accommodate this), in the sidewalls (linear tube couplings can be used), or even in the bottom wall.

In this arrangement, the inlet and outlet penetrations in the watertight housing 112 are made by tubing penetrations, instead of fitting/connector penetrations as in the first embodiment. Generally, sealed tubing penetrations are less likely to leak water than fitting/connector penetrations. As a result, the system 110 is generally less likely to leak water in the event of an internal leak (in the filter canister 118, the filter-mounting cap 114, or the internal connections).

In addition, in this arrangement, the two (inlet and outlet) pivotal connections (that enable the filter canister 118 to pivot between stored and pivoted positions) are internal to the watertight housing 112 (whereas the pivotal connections are external when using some swivel fittings in the first embodiment). So all potential leak points (the inlet and outlet tubing connections and pivotal connections) are located within the watertight housing 112. This further reduces the potential for water leaks by the system 110.

Also, in this arrangement, the tube couplings 116 can be more quickly and easily replaced for maintenance purposes. This is because the tube couplings 116 in this embodiment do not extend through the hosing 112, and so the housing 112 does not have to be removed in order to replace the tube couplings 116. In addition to saving maintenance time, this encourages scheduled maintenance to further reduce the risk of a water leak.

In addition, in the system 110 of this embodiment, the filter support 146 is provided by the inner surface of the tail portion 142 of the housing 112 having a shape that conforms to the shape of the tail end 126 of the filter canister 118. For example, for the depicted cylindrical filter canister 118, the housing tail portion 142 has a conforming curvature on at least a portion of its inner surface. The conforming curvature portion can extend laterally for an arc of at least 10 degrees (typically 120 degree to 180 degrees, e.g., about 140 degrees as depicted), and longitudinally for at least some of the housing tail portion 142 (typically for the entire length of the filter canister 118, see FIG. 27). This conforming shape cradles and supports at least the free tail portion 126 of the filter canister 118 (and the entire filter canister 118 in the depicted embodiment) so that in horizontal installations (with the filter canister horizontally orientated) the filter canister 118 is not cantilevered at the filter-mounting cap 114 to minimize the potential for leaks. Also, the depicted conforming curvature portion extending for an arc of 120 degree to 180 degrees enable it to contact and support the filter canister 118 when the water-filtration system 110 is in the horizontal orientation with the open/access side of the housing 112 facing laterally or facing upwards (or anywhere in between). This extensive (cradling/nesting) contact of the filter support 146 to the filter canister 118 distributes loading to ensure there is no overloading.

Furthermore, in the system 110 of this embodiment, the retainer 150 that releasably secures the filter canister 118 in the housing 112 is provided by a clamp (see FIG. 27). The clamp 150 can be a U-shaped member with two prongs and an open top through which the tail handle 128 of the filter canister is received. The prongs (at least one of them) can be made of a resilient material so that they deflect/deform outwardly apart (to the clearance configuration) upon pivoting engagement by the handle 150 and resiliently return inwardly (to the retaining configuration) upon the handle 150 clearing them. In the depicted embodiment, one prong of the clamp 150 inserts into the fingerhole of the handle 150. The retainer 150 can be located on the bottom wall of the housing body 130. The retainer 150 thereby functions to help hold the filter canister 118 in place during use. For example, in RV installations, the retainer 150 secure the filter canister 118 in place with sufficient force to prevent the filter from pivoting out of place due to vibrations caused from the RV traveling during its ordinary intended use. Persons of ordinary skill in the art understand that the retainer can be readily adapted to retain other types of handles in other embodiments to provide the same functionality.

In some embodiments, the tube couplings are provided integrally as parts of the filter-mounting cap, and in some embodiments the tube couplings are not included (the rotation of the filter canister can be provided for example by the filter-mounting cap having the dual-flow portion being rotational relative to the inlet and outlet). Also, in the embodiments described herein, the inlet and outlet penetrations in the watertight housing are made by tubing penetrations, fitting/connector penetrations, or other fluid-carrying elements with a watertight seal.

In additional embodiments, the housing is insulated to protect the filter canister from harsh temperatures. For example, the housing can include a double-walled design with an air gap between the walls for air insulation. The insulated design helps prevent water in the filter canister from freezing in extremely cold conditions, for example when the system is inset-mounted into an exterior wall of an RV.

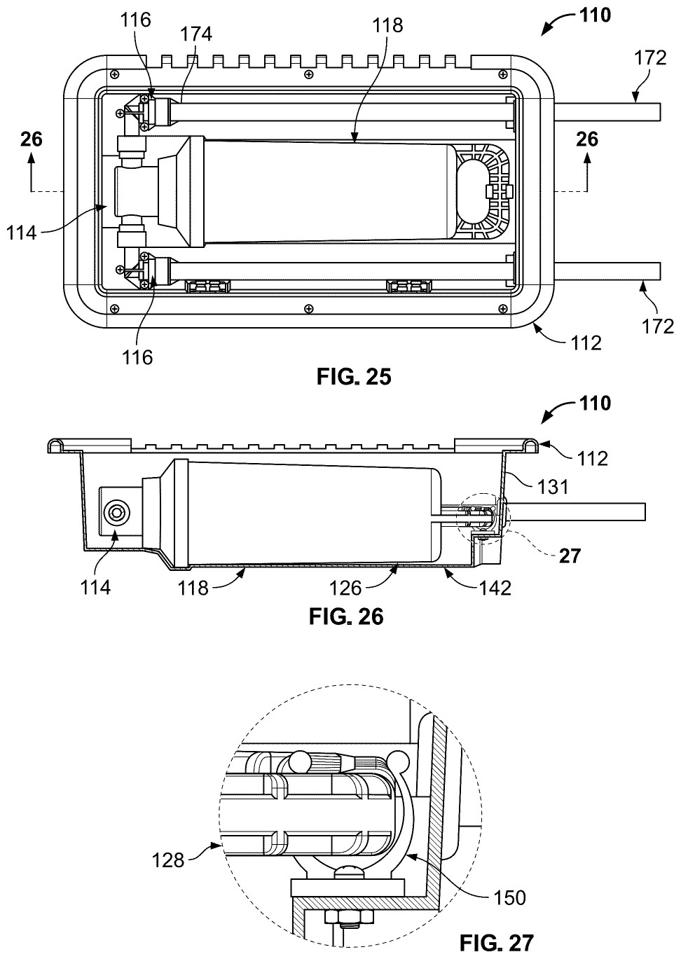

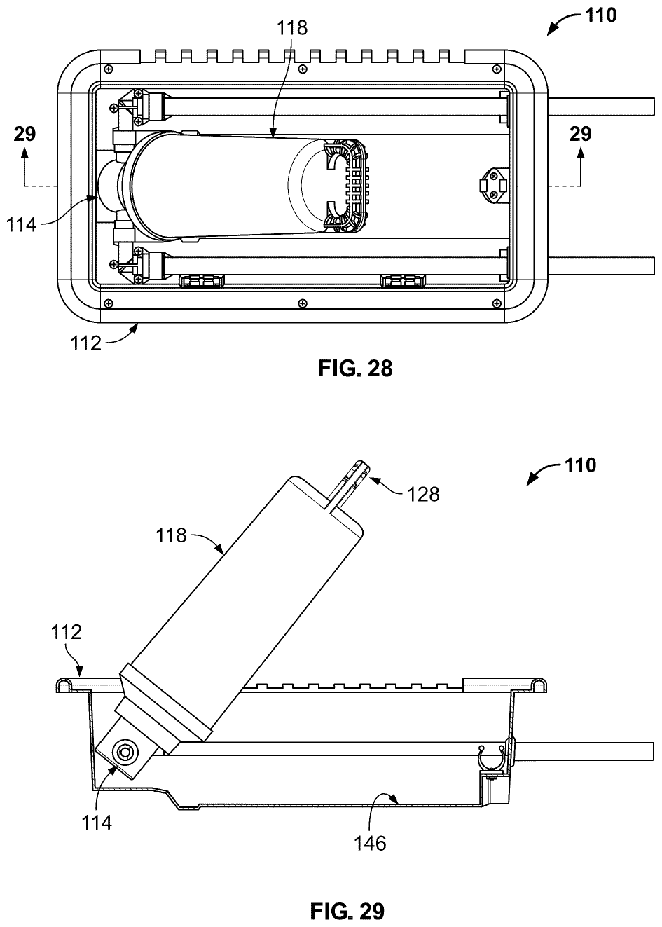

Methods of installing and using the water-filtration system 110 are the same as for the first embodiment, expect as noted above. FIGS. 25-26 show the water-filtration system 110 with the filter canister 118 in the stored position for use, within the housing 112. And FIGS. 28-29 show the water-filtration system 110 with the filter canister 118 in the pivoted position for replacement, with its tail end portion (and handle 128) extending out of the housing 112 so it can be grasped by hand to move and detach the filter canister 118 from the filter-mounting cap 114.

In addition to the water-filtration systems described above (with the filter canister included or separately provided), also disclosed as aspects of the invention are installation methods including installing the water-filtration systems inset-mounted into surfaces (including new construction and retrofit installations), and maintenance methods including pivotally repositioning and replacing the filter canisters of such systems, all as described above.

While the invention has been described with reference to example embodiments, it will be understood by those skilled in the art that a variety of modifications, additions, and deletions are within the scope of the invention, as defined by the following claims.

What is claimed is:

1. A water-filtration system, comprising:
a replaceable filter canister having a head end portion and an opposite free tail end portion,
a filter housing having a body with an access opening and having a lid movable between a closed position covering the access opening side and an open position exposing the access opening, wherein the housing receives the replaceable filter canister through the access opening;
a filter-mounting cap positioned within the housing, rotationally mounted relative to the housing, and removably attached to the head end portion of the replaceable filter canister, wherein the replaceable filter canister and the removably attached filter-mounting cap are together repositionable between a stored position for use and a pivoted position for filter replacement, wherein in the stored position the replaceable filter canister and the removably attached filter-mounting cap are positioned within the filter housing, and wherein in the pivoted position the replaceable filter canister free tail end portion is displaced from the filter housing through the access opening so that it can be grasped to detach and replace the replaceable filter canister.

2. The water-filtration system of claim 1, wherein the housing mounts to a surface with the housing body inset into the surface and with the housing lid flush with the surface.

3. The water-filtration system of claim 1, wherein the housing mounts to an exterior or interior wall of a recreational vehicle with the housing body inset into the wall and with the housing lid flush with the wall.

4. The water-filtration system of claim 1, wherein the housing is watertight when the lid is in the closed position, and wherein the filter canister is watertight.

5. The water-filtration system of claim 1, wherein the filter-mounting cap includes an inlet and an outlet that are axially aligned and define a rotational axis about which the filter-mounting cap rotates relative to the housing.

6. The water-filtration system of claim 5, wherein the filter-mounting cap is T-shaped with a dual-flow portion extending perpendicular to the axially aligned inlet and outlet, wherein the filter-mounting cap is removably attached to the head end portion of the replaceable filter canister by the dual-flow portion.

7. The water-filtration system of claim 1, wherein the housing body includes an inlet opening and an outlet opening through which an inlet tube coupling and an outlet tube coupling extend with a watertight seal, respectively, or through which an inlet line and an outlet line can be extended with a watertight seal, respectively.

8. The water-filtration system of claim 1, further comprising an inlet tube coupling connected to the inlet of the filter-mounting cap and an outlet tube coupling connected to the outlet of the filter-mounting cap.

9. The water-filtration system of claim 8, wherein the inlet tube coupling and the outlet tube coupling are swivel fittings that provide the rotational mounting of the filter-mounting cap relative to the housing.

10. The water-filtration system of claim 8, wherein the inlet tube coupling and the outlet tube coupling extend through the housing body with a watertight seal.

11. The water-filtration system of claim 8, wherein the housing body includes an inlet opening and an outlet opening through which an inlet line and an outlet line can be extended with a watertight seal, respectively, wherein the inlet tube coupling can be connected to the inlet line and the outlet tube coupling can be connected to the outlet line.

12. The water-filtration system of claim 11, wherein the inlet tube coupling and the outlet tube coupling are positioned entirely within the housing.

13. The water-filtration system of claim 1, wherein the housing further comprises a retainer that releasably secures the filter canister in the housing.

14. The water-filtration system of claim 1, wherein the housing further comprises a filter support that supports the free tail end portion of the filter canister in the housing when the water-filtration system is installed in a horizontal position.

15. A method of maintaining the water-filtration system of claim 1, comprising:
moving the lid from the closed position to the open position;
manually grasping the replaceable filter canister free tail end portion and pivoting the replaceable filter canister and the removably attached filter-mounting cap from the stored position to the pivoted position;
detaching the replaceable filter canister from the filter-mounting cap;
removably attaching a fresh replaceable filter canister to the filter-mounting cap;
pivoting the fresh replaceable filter canister and the removably attached filter-mounting cap to the stored position; and
moving the lid to the closed position.

16. A fluid-filtration system for use with a replaceable filter canister having a head end portion and an opposite free tail end portion, the fluid-filtration system comprising:
a filter housing having a body with an access opening and having a lid movable between a closed position covering the access opening side and an open position exposing the access opening, wherein the housing is watertight when the lid is in the closed position, wherein the housing receives the replaceable filter canister through the access opening, wherein the housing mounts to a surface with the housing body inset into the surface and with the housing lid flush with the surface;
a filter-mounting cap positioned within the housing, rotationally mounted relative to the housing, and removably attached to the head end portion of the replaceable filter canister, wherein the filter-mounting cap includes an inlet and an outlet that are axially aligned and define a rotational axis about which the filter-mounting cap rotates relative to the housing, wherein the filter-mounting cap is T-shaped with a dual-flow portion extending perpendicular to the axially aligned inlet and outlet, wherein the filter-mounting cap is removably attached to the head end portion of the replaceable filter canister by the dual-flow portion, wherein the replaceable filter canister and the removably attached filter-mounting cap are together repositionable between a stored position for use and a pivoted position for filter replacement, wherein in the stored position the replaceable filter canister and the removably attached filter-mounting cap are positioned within the filter housing, and wherein in the pivoted position the replaceable filter canister free tail end portion is displaced from the filter housing through the access opening so that it can be grasped to detach and replace the replaceable filter canister.

17. The water-filtration system of claim 16, wherein the housing mounts to an exterior or interior wall of a recreational vehicle with the housing body inset into the wall and with the housing lid flush with the wall.

18. The water-filtration system of claim 16, wherein the housing body includes an inlet opening and an outlet opening through which an inlet tube coupling and an outlet tube coupling extend with a watertight seal, respectively, or through which an inlet line and an outlet line can be extended with a watertight seal, respectively.

19. The water-filtration system of claim 16, further comprising an inlet tube coupling connected to the inlet of the filter-mounting cap and an outlet tube coupling connected to the outlet of the filter-mounting cap, wherein the inlet tube coupling and the outlet tube coupling are swivel fittings that provide the rotational mounting of the filter-mounting cap relative to the housing.

20. A system for on-site filtration of drinking water, comprising:
a replaceable filter canister having a head end portion and an opposite free tail end portion;
a filter housing having a body with an access opening and having a lid movable between a closed position covering the access opening side and an open position exposing the access opening, wherein the housing is watertight when the lid is in the closed position, wherein the housing receives the replaceable filter canister through the access opening, wherein the housing mounts to a surface with the housing body inset into the surface and with the housing lid flush with the surface;
a filter-mounting cap positioned within the housing, rotationally mounted relative to the housing, and removably attached to the head end portion of the replaceable filter canister, wherein the filter-mounting cap includes an inlet and an outlet that are axially aligned and define a rotational axis about which the filter-mounting cap rotates relative to the housing, wherein the filter-mounting cap is T-shaped with a dual-flow portion extending perpendicular to the axially aligned inlet and outlet, wherein the filter-mounting cap is removably attached to the head end portion of the replaceable filter canister by the dual-flow portion, wherein the replaceable filter canister and the removably attached filter-mounting cap are together repositionable between a stored position for use and a pivoted position for filter replacement, wherein in the stored position the replaceable filter canister and the removably attached filter-mounting cap are positioned within the filter housing, and wherein in the pivoted position the replaceable filter canister free tail end portion is displaced from the filter housing through the access opening so that it can be grasped to detach and replace the replaceable filter canister.
